(19) United States
(12) Patent Application Publication
(10) Pub. No.: US 2024/0371251 A1
(43) Pub. Date: Nov. 7, 2024

(54) STATUS NOTIFICATION UNIT

(71) Applicant: PATLITE CORPORATION, Osaka (JP)

(72) Inventors: Takuya AONO, Osaka (JP); Kenichiro KUROSAWA, Osaka (JP); Ryuzo TAKATA, Osaka (JP); Shiin YASUI, Osaka (JP); Hiroki TAKATA, Osaka (JP)

(73) Assignee: PATLITE CORPORATION, Osaka (JP)

(21) Appl. No.: 18/247,434

(22) PCT Filed: Oct. 29, 2021
(86) PCT No.: PCT/JP2021/040034

§ 371 Date: Mar. 30, 2023

(51) Int. Cl. G08B 21/18; G08B 3/10; G08B 5/38

(52) U.S. Cl. CPC G08B 21/18; G08B 5/38; G08B 3/10

(57) ABSTRACT

A status notification unit that provides a notification regarding a status of a monitored device, using a light emission unit and a voice unit, the monitored device generating first event information that includes light emission data regarding light emission, and second event information that includes text data corresponding to a voice, the status notification unit including: an acceptance unit configured to accept the first event information and the second event information from the monitored device; a light emission control unit that controls light emission performed by the light emission unit, based on the first event information accepted by the acceptance unit; a voice data generation unit that generates voice data to be played back by the voice unit, based on the second event information accepted by the acceptance unit; and a voice control unit that controls the voice to be played back by the voice unit.

### TECHNICAL FIELD

The present invention relates to a status notification unit, a status notification method, a status notification program, and a status notification device.

### BACKGROUND ART

Conventionally, an alarm device has been proposed that provides a voice notification regarding the status of a monitored device when the status thereof changes such as when an abnormality occurs therein (for example, Patent Document 1).

### CITATION LIST

### Patent Literature

Patent Literature 1: JP 2010-108027A

### SUMMARY OF INVENTION

### Technical Problem

However, the alarm device according to Patent Literature 1 requires that voice data indicating a status be prepared in advance, and therefore there is a problem in that it takes a long time to generate voice data. In addition, the volume of voice data is large, and therefore it is difficult to generate various types of voice data. Such problems are not specific to alarm devices, but may occur in all devices that provide notifications regarding status changes. The present invention has been made to solve the aforementioned problems, and aims to provide a status notification unit, a status notification method, a status notification program, and a status notification device that can easily generate various voices for providing status notifications.

### Solution to Problem

A first status notification unit according to the present invention is a status notification unit that provides a notification regarding a status of a monitored device, using a light emission unit and a voice unit, the monitored device generating first event information that includes light emission data regarding light emission, and second event information that includes text data corresponding to a voice to be played back, the status notification unit including: an acceptance unit configured to accept the first event information and the second event information from the monitored device; a light emission control unit that controls light emission performed by the light emission unit, based on the first event information accepted by the acceptance unit; a voice data generation unit that generates voice data to be played back by the voice unit, based on the second event information accepted by the event information acceptance unit; and a voice control unit that controls the voice to be played back by the voice unit, based on the voice data.

In the first status notification unit according to the present invention, the light emission control unit may be configured to change a method by which the light emission unit emits light, based on the second event information.

In the first status notification unit according to the present invention, the voice data generation unit may generate the voice data so as to change at least one of a volume, pitch, timbre, and playback speed of the voice to be played back according to the content of the text data included in the second event information.

In the first status notification unit according to the present invention, the voice control unit controls the voice unit so as to change at least one of a volume, pitch, timbre, and playback speed of the voice to be played back according to the content of the text data included in the second event information.

The first status notification unit according to the present invention may further include a storage unit that stores the generated voice data, and the voice control unit may be configured to, when text data that is the same as the text data included in the second event information accepted in the past is received, control the voice to be played back by the voice unit, based on the voice data stored in the storage unit.

In the first status notification unit according to the present invention, the voice data generation unit generates the voice data so that the voice data includes at least one of: times at which the first and second event information were accepted; and information for specifying the monitored device.

The first status notification unit according to the present invention may further include a playback command acceptance unit that accepts a command for playing back the voice, and the voice control unit may perform control so that the voice unit plays back the voice when the playback command is accepted by the playback command acceptance unit.

A first status notification device according to the present invention includes: a light emission unit that emits light; a voice unit that emits a voice; and any of the above-described information notification units.

A second status notification device according to the present invention includes: a light emission unit that emits light; a voice unit that emits a voice; a playback switch; and a status notification unit that includes the above-described playback command acceptance unit, and the playback command acceptance unit is configured to accept the playback command via the playback switch.

A first status notification method according to the present invention is a status notification method for providing a notification regarding a status of a monitored device, using a light emission unit and a voice unit, the monitored device generating first event information that includes light emission data regarding light emission, and second event information that includes text data corresponding to a voice to be played back, the status notification method including: a step of accepting the first event information and the second event information from the monitored device; a step of generating voice data to be played back by the voice unit, based on the accepted second event information; a step of controlling the voice to be played back by the voice unit, based on the voice data; and a step of controlling light emission performed by the light emission unit, based on the accepted first event information. Note that the step of controlling the light emission may be performed before the step of generating the voice data or the step of controlling the voice.

A first status notification program according to the present invention is a status notification program for providing a notification regarding a status of a monitored device, using a light emission unit and a voice unit, the monitored device generating first event information that includes light emission data regarding light emission, and second event information that includes text data corresponding to a voice to be played back, the status notification program enabling a computer to carry out: a step of accepting the first event information and the second event information from the monitored device; a step of generating voice data to be played back by the voice unit, based on the accepted second event information; a step of controlling the voice to be played back by the voice unit, based on the voice data; and a step of controlling light emission performed by the light emission unit, based on the accepted first event information. Note that the step of controlling the light emission may be performed before the step of generating the voice data or the step of controlling the voice.

A second status notification unit according to the present invention is a status notification unit that provides a notification regarding a monitored device, using a light emission unit and a voice unit, the status notification unit including: an event information generation unit that monitors a status of the monitored device, and generates first event information that includes light emission data regarding light emission, and second event information that includes text data corresponding to a voice to be played back, based on a monitored event; a light emission control unit that controls light emission performed by the light emission unit, based on the first event information; a voice data generation unit that generates voice data to be played back by the voice unit, based on the second event information; and a voice control unit that controls the voice to be played back by the voice unit, based on the voice data.

In the second status notification unit according to the present invention, the light emission control unit may be configured to change a method by which the light emission unit emits light, based on the second event information.

In the second status notification unit according to the present invention, the voice data generation unit may generate the voice data so as to change at least one of a volume, pitch, timbre, and playback speed of the voice to be played back according to the content of the text data included in the second event information.

In the second status notification unit according to the present invention, the voice control unit may control the voice unit so as to change at least one of a volume, pitch, timbre, and playback speed of the voice to be played back according to the content of the text data included in the second event information.

The second status notification unit according to the present invention may further include a storage unit that stores the generated voice data, and the voice control unit may be configured to, when text data that is the same as the text data included in the second event information accepted in the past is received, control the voice to be played back by the voice unit, based on the voice data stored in the storage unit.

In the second status notification unit according to the present invention, the event information generation unit may generate the second event information so as to include at least one of: the time at which the event was monitored; and information for specifying the monitored target, in the text data.

The second status notification unit according to the present invention may further include a playback command acceptance unit that accepts a command for playing back the voice, and the voice control unit may perform control so that the voice unit plays back the voice when the playback command is accepted by the playback command acceptance unit.

A third status notification device according to the present invention includes: a light emission unit that emits light; a voice unit that emits a voice; and any of the above-described second information notification units.

A fourth status notification device according to the present invention includes: a light emission unit that emits light; a voice unit that emits a voice; a playback switch; and the above-described second status notification unit that includes a playback command acceptance unit, and the playback command acceptance unit is configured to accept the playback command via the playback switch.

A second status notification method according to the present invention is a status notification method for providing a notification regarding a monitored device, using a light emission unit and a voice unit, the status notification method including: a step of monitoring a status of the monitored device, and generating first event information that includes light emission data regarding light emission, and second event information that includes text data corresponding to a voice to be played back, based on a monitored event; a step of generating voice data to be played back by the voice unit, based on the second event information; a step of controlling the voice to be played back by the voice unit, based on the voice data; and a step of controlling light emission performed by the light emission unit, based on the first event information. Note that the step of controlling the light emission may be performed before the step of generating the voice data or the step of controlling the voice.

A second status notification program according to the present invention is a status notification program for providing a notification regarding a status of a monitored device, using a light emission unit and a voice unit, the status notification program enabling a computer to carry out: a step of monitoring a status of the monitored device, and generating first event information that includes light emission data regarding light emission, and second event information that includes text data corresponding to a voice to be played back, based on a monitored event; a step of generating voice data to be played back by the voice unit, based on the second event information; a step of controlling the voice to be played back by the voice unit, based on the voice data; and a step of controlling light emission performed by the light emission unit, based on the first event information. Note that the step of controlling the light emission may be performed before the step of generating the voice data or the step of controlling the voice.

### Advantageous Effects of Invention

According to the present invention, it is possible to easily generate various voices for providing status notifications.

### BRIEF DESCRIPTION OF DRAWINGS

FIG. 1 shows an example configuration of an embodiment of a system that includes a status notification device according to the present invention.

FIG. 2 is a block diagram showing a hardware configuration of a production facility.

FIG. 3 is a diagram showing an example of a data structure for an internal memory of a PLC of the production facility.

FIG. 4 is a diagram showing an example of a transmission data structure.

FIG. 5 is a diagram showing an example of the transmission data structure.

FIG. 6 is a front view of the status notification device.

FIG. 7 is a rear view of the status notification device.

FIG. 8 is a block diagram showing a hardware configuration of the status notification device.

FIG. 9 is a block diagram showing a software configuration of the status notification device.

FIG. 10 is a flowchart for status notification that is performed by the status notification device in a case where a playback switch is set to a first setting.

FIG. 11 is a flowchart for status notification that is performed by the status notification device in a case where the playback switch is set to a second setting.

FIG. 12 is a block diagram showing a software configuration of a status notification device according to a second embodiment.

FIG. 13 is a diagram showing an example of notification data.

### DESCRIPTION OF EMBODIMENTS

### A. First Embodiment

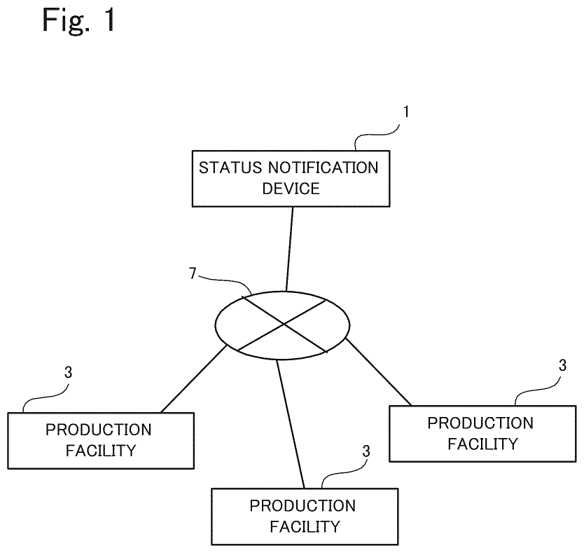

Hereinafter, a first embodiment of a status notification device according to the present invention will be described with reference to the drawings. In the following, a status notification device that provides a notification regarding the status of a production facility will be described as an example of a monitored device. FIG. 1 shows an example configuration of a system that includes such a status notification device, and includes a status notification device 1 and a plurality of production facilities 3 that are connected to the status notification device 1 via a network 7. The status notification device 1 according to the present embodiment is configured to provide notifications regarding the status of each production facility 3 by emitting light and voices. The following describes each component in detail.

### <1. Hardware Configuration>

### <1-1. Production Facilities>

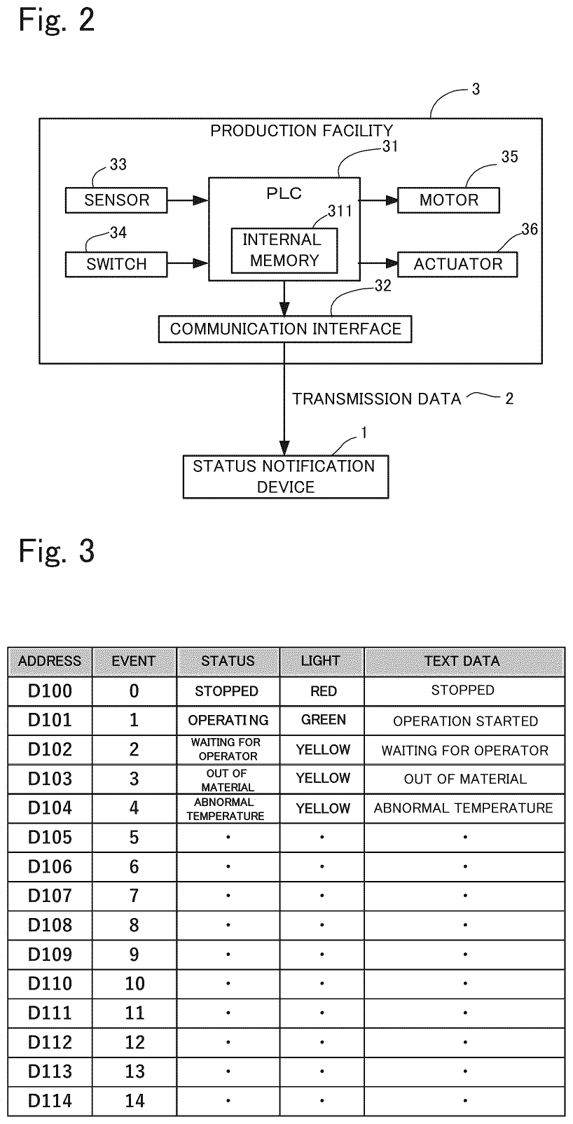

FIG. 2 is a block diagram showing a hardware configuration of each production facility. As shown in FIG. 2, each production facility 3 is provided with a PLC (Programmable Logic Controller) 31 and a communication interface 32, and a motor 35 and an actuator 36 are controlled based on inputs from a sensor 33 and a switch 34 to the PLC 31. An internal memory 311 provided in the PLC 31 is configured such that the status of the production facility 3 is sequentially written thereto. The information written to the internal memory 311 is to be transmitted by the communication interface 32 to the status notification device 1.

FIG. 3 is a diagram showing an example of a data structure for the internal memory. As shown in FIG. 3, this internal memory 311 stores “memory address”, “event number”, “status”, “light”, and “text data” for voice messages. “Event number” is a number assigned to an event in ascending order each time an event occurs, and “status” indicates the status of the production facility 3. In this example, six statuses, namely “stopped”, “operating”, “waiting for operator”, “out of material”, and “abnormal temperature”, are defined. However, various other statuses can be defined.

“Light” is information indicating the color, the lighting status, etc. of the light emitted by the status notification device 1, and is defined for each of the statuses described above. In the example in FIG. 3, only the color of light is specified. However, it is also possible to specify the lighting pattern of a flashing light. Similarly, text data is also defined for each of the statuses described above. These items can be appropriately set by the user according to the structure and use mode of the target production facility 3.

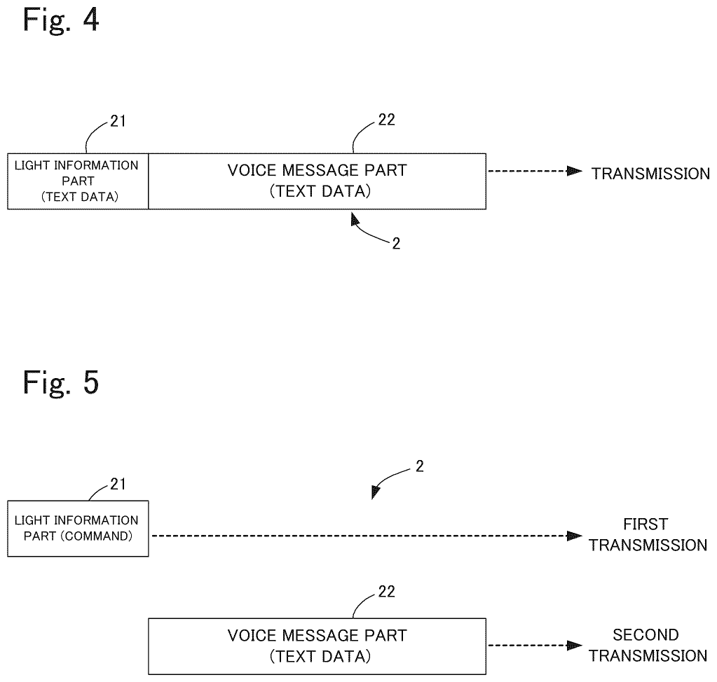

The PLC 31 generates transmission data 2 that is in a format suitable for the status notification device 1 from the information written to the internal memory 311. As shown in FIG. 4, for example, the transmission data 2 is constituted by text data that includes an optical information part (first event information) 21 and a voice message part (second event information) 22. The light information part 21 is constituted by text data such as “light, red lighting”, “light, yellow lighting”, “light, yellow flashing 1”, “light, yellow flashing 2”, etc., and includes the color and lighting pattern of the light. The lighting pattern can be specified by, for example, one of the texts such as “lighting”, “flashing 1”, and “flashing 2”, which indicate a constantly lit state and two different patterns of flashing state.

The voice message section 22 is acquired by extracting the text data written to the internal memory 311, and is constituted by text data such as “sound has stopped”, for example. Transmission data 2 that includes the light information part 21 and the voice message part 22 as pieces of text data is generated each time the internal memory 311 is rewritten, and such transmission data 2 is transmitted by the communication interface 32 to the status notification device 1.

The format of the transmission data 2 is not limited to that described above, and various formats can be employed so as to be suitable for the status notification device 1. For example, as shown in FIG. 5, the light information part 21 may be a command indicating the color and lighting state of light instead of text data. The command can be written in various forms, and can be represented, for example, by numbers, characters, symbols, etc. that are defined so as to be readable by the status notification device 1. The voice message part 22 to be generated together with this command is as described above. In this case, the formats of the light information part 21 and the voice message part 22 are different, and therefore the communication interface 32 transmits the transmission data 2 in two separate transmissions. For example, the command for the optical information part 21 may be transmitted first, and the text data for the voice message part 22 may be transmitted second. Note that the order of these transmissions may be reversed.

The communication interface 32 is, for example, a wired LAN (Local Area Network) module, a wireless LAN module, or the like, and is an interface for wired or wireless communication. That is to say, the communication interface 32 is configured to transmit the transmission data 2 to the status notification device 1 via a wired or wireless network 7 according to a predetermined communication protocol.

### <1-2. Status Notification Device>

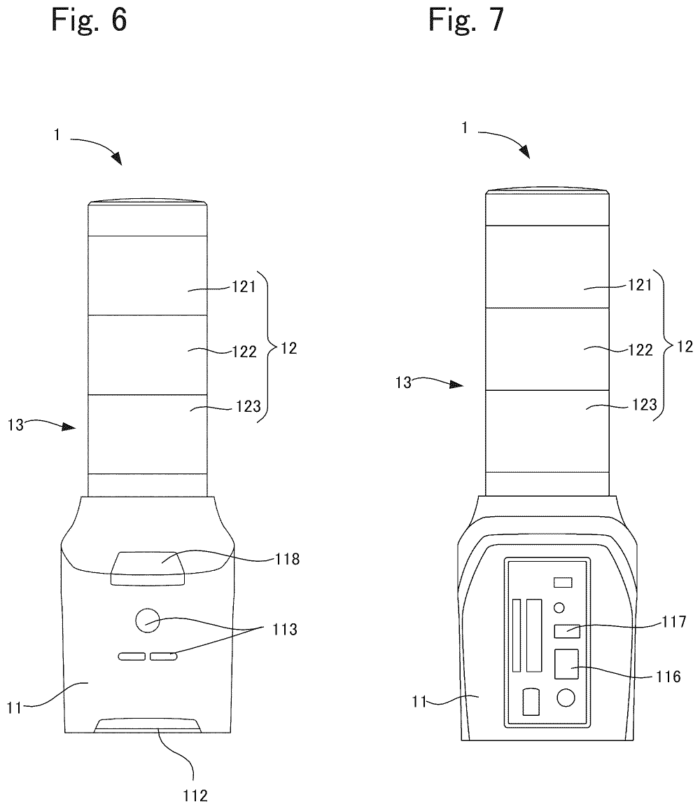

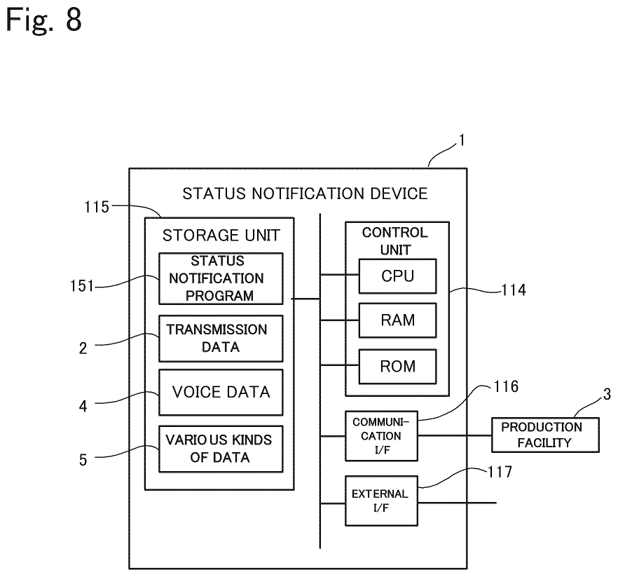

Next, an example of a hardware configuration of the status notification device 1 according to the present embodiment will be described. FIG. 6 is a front view of the status notification device, FIG. 7 is a rear view of the status notification device, and FIG. 8 shows an example of a hardware configuration of the status notification device.

As shown in FIGS. 5 to 7, the status notification device 1 includes a base 11, an LED unit (a light emitting unit) 12 that extends from an upper portion of the base 11, and a body 13. A speaker (a voice unit) 112 and various operation buttons 113 are provided on the outer surface of the base 11. A control unit 114, a storage unit 115, a communication interface 116, and an external interface 117 are built into the base 11. Note that, in FIG. 8, the communication interface 116 is denoted as the “communication I/F” and the external interface 117 is denoted as the “external I/F”.

The base 11 is formed in a rectangular shape in plan view, and functions as a housing for housing the control unit 114, etc. The LED unit 12 is formed in a columnar shape, and an upper portion thereof is provided with three light emitting portions, namely first, second, and third light emitting portions 121 to 123 that are lined up from top to bottom. Each of the light emitting portions 121 to 123 is formed in a columnar shape, and LEDs are built thereinto so as to emit red, yellow, and green light, respectively. These light emitting portions 121 to 123 emit light according to the status of the aforementioned production facility 3.

As shown in FIG. 6, a lower portion of the front surface of the base 11 is provided with the aforementioned speaker 112, and this speaker 112 outputs voices representing the status of the production facility 3. Although not shown in the drawings, a volume switch for adjusting the volume of voices is also provided. In addition, the various operation buttons 113 are provided on the front surface of the base 11 above the speaker 112. Examples of the operation buttons 113 include a reset switch (not shown) for resetting the operation, a playback switch 118 for voices, and so on.

The playback switch 118 is a switch for playing back voices. In the present embodiment, the playback switch 118 can be used to set two types of settings for voice playback. A first setting is a setting for outputting the status of the production facility 3 from the speaker 112 without the playback switch 118 being pressed. On the other hand, a second setting is a setting for outputting the status of the production facility 3 from the speaker 112 only when the playback switch 118 is pressed. The use of these settings will be described later. In addition, the operation buttons 113 may include other buttons, switches, etc. with various functions as required.

As shown in FIG. 7, the rear surface of the base 11 is provided with connectors for the aforementioned communication interface 116 and external interface 117.

Next, the control unit 114 will be described. As shown in FIG. 8, the control unit 114 includes a CPU, a RAM, a ROM, etc., and is configured to carry out various kinds of information processing based on programs and data. The storage unit 115 is constituted by an auxiliary storage device such as an HDD or a SDD, for example, and stores a status notification program 151, transmission data 2, voice data 4, and various kinds of data 5 for driving the status notification device 1. The status notification program 151 is a program for enabling the status notification device 1 to provide a notification regarding the status of the production facility 3. The control unit 114 is configured to carry out the processing in each of the steps described below by interpreting and executing the status notification program 151.

The external interface 117 is an interface for connecting to external devices, and is appropriately configured according to the external devices to be connected. For example, an input device such as a keyboard and an output device such as a display can be appropriately connected to the external interface 117.

The communication interface 116 is the same as the communication interface provided in the production facility 3, and therefore the description thereof will be omitted.

Regarding the specific hardware configuration of the status notification device 1, it is possible to omit, replace, and add components as appropriate according to the embodiment. For example, the control unit 114 may include a plurality of processors. Also, the control unit 114 may be constituted by an FPGA. The storage unit 115 may be constituted by the RAM and ROM included in the control unit 114.

### <2. Software Configuration of Status Notification Device>

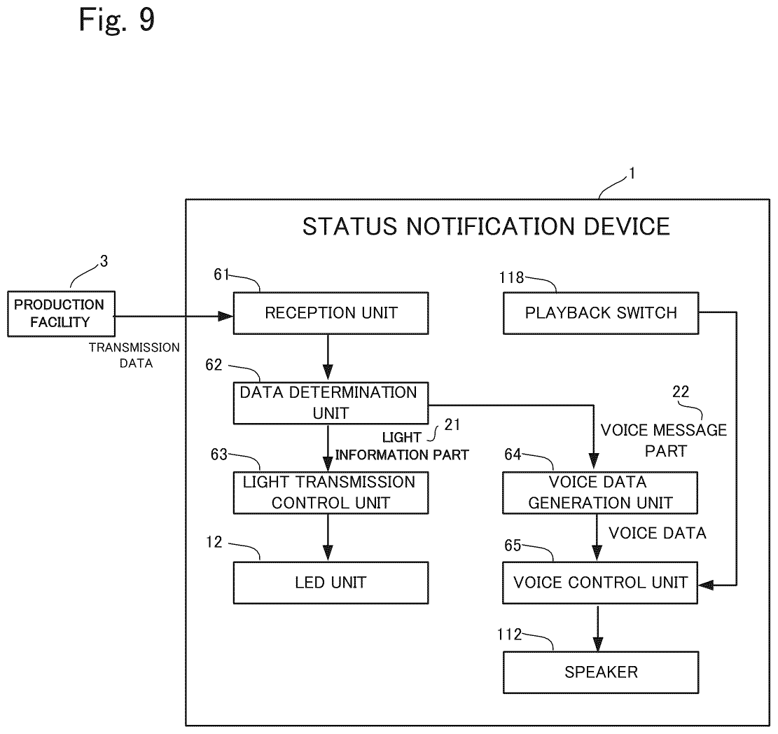

Next, a software configuration of the status notification device 1 will be described. FIG. 9 is a block diagram showing a software configuration of the status notification device. As shown in FIG. 9, the control unit 114 of the status notification device 1 loads the status notification program 151 stored in the storage unit 115 to the RAM, and thereafter interprets and executes the status notification program 151, using the CPU thereof, to function as a computer that includes a reception unit (acceptance unit) 61, a data determining unit (acceptance unit) 62, a light emission control unit 63, a voice data generation unit 64, and a voice control unit 65.

The reception unit (acceptance unit) 61 receives the transmission data 2 transmitted from the production facility 3. The received transmission data 2 is stored in the storage unit 115 or the RAM.

The data determination unit (acceptance unit) 62 extract the light information part 21 and the voice message part 22 from the transmission data 2 received by the reception unit (acceptance unit) 61, and transmits the light information part 21 and the voice message part 22 to the light emission control unit 63 and voice data generation unit 64 described below. For example, when the transmission data 2 is in the format of text data, the data determination unit (acceptance unit) 62 extracts text data such as “light, red lighting” as data to be transmitted to the light emission control unit 63, and text data such as “sound has stopped” as data to be transmitted to the voice data generation unit 64. Note that the reception unit (acceptance unit) 61 and the data determining unit (acceptance unit) 62 constitute the acceptance unit according to the present invention.

On the other hand, when the transmission data 2 is constituted by two pieces of data transmitted separately, the command in the light information part 21 is transmitted to the light emission control unit 63, and the text data in the voice message part 22 is transmitted to the voice data generation unit 64.

The light emission control unit 63 has the function of control the light emission by the LED unit 12 based on the data in the light information part 21 received from the data determining unit (acceptance unit) 62. For example, upon receiving text data such as “light, red lighting”, the light emission control unit 63 converts the text data into a command, and causes the first light emitting portion 121 in the LED unit 12 to emit light, using the command. If a command is transmitted from the data determining unit (acceptance unit) 62, the light emission control unit 63 controls the light emission of the LED unit 12, using the command. In addition, the light emission control unit 63 can also control the intensity of light, adjust the color thereof, control the duration of light emission, etc.

The voice data generation unit 64 generates voice data in the format of MP3, WAV, etc. from the text data in the voice message part 22 received from the data determining unit (acceptance unit) 62. For example, the voice data generation unit 64 generates voice data that reads out the text data using the well-known Text-to-Speech (TTS) technique. The generated voice data is transmitted to the voice control unit 65. In addition, the generated voice data is stored in the storage unit 115.

The voice control unit 65 controls the speaker 112 so as to output a voice reading out the text data based on the voice data transmitted from the voice data generation unit 64. In addition, the voice control unit 65 can also control the volume, pitch, timbre, and playback speed of the voice. In addition to the above functions, the voice control unit 65 also functions as a playback command reception unit when the playback switch 118 is pressed, and plays back a voice according to the playback command generated when the playback switch 118 is pressed.

<3. Method Carried Out by Status Notification Device to Provide Notification regarding Status of Production Facility>

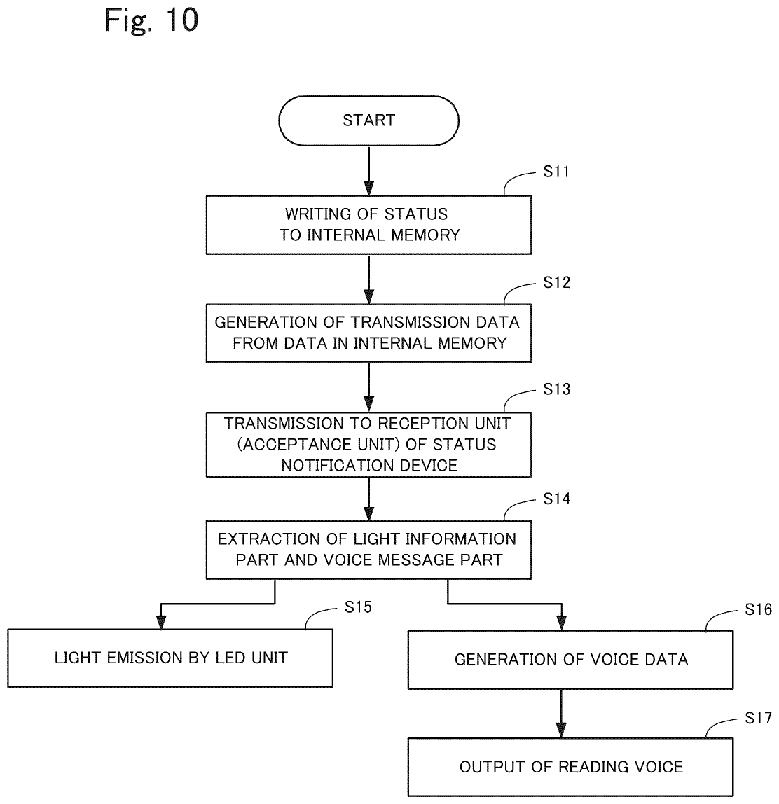

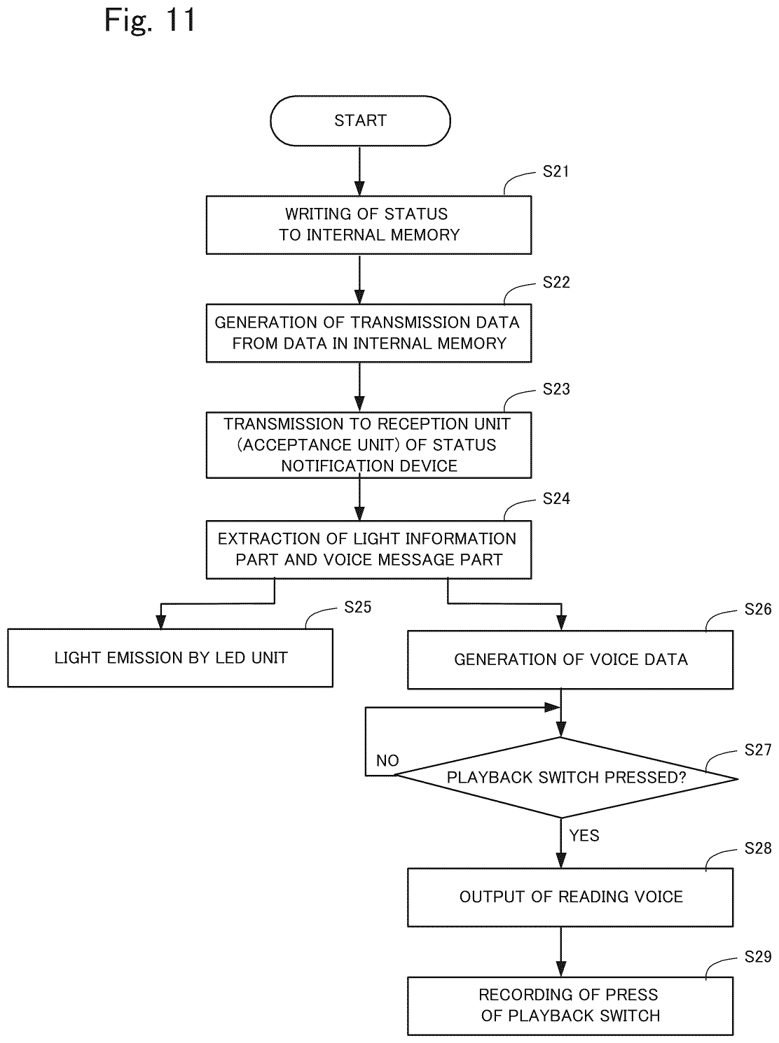

Next, a method carried out by the status notification device with the above-described configuration to provide a notification regarding a production facility will be described with reference to the flowcharts in FIGS. 10 and 11.

First, a case in which the above-described playback switch 118 is set to the first setting will be described with reference to the flowchart in FIG. 10. As shown in FIG. 10, upon the status of the production facility 3 being written to the internal memory 311 of the production facility 3 (step S11), the PLC 31 generates transmission data 2 from the data in the internal memory 311 as described above (step S12). The generated transmission data 2 is transmitted to the reception unit (acceptance unit) 61 of the status notification device 1 (step S13).

The transmission data 2 received by the reception unit (acceptance unit) 61 is transmitted to the data determining unit (acceptance unit) 62, and the data determining unit (acceptance unit) 62 extracts text data or a command from the light information part 21, and extracts text data from the voice message part 22 (step S14).

The extracted text data or command of the light information part 21 is transmitted to the light emission control unit 63, which causes the LED unit 12 to emit light (step S15). In parallel with this operation, the extracted text data of the voice message part 22 is transmitted to the voice data generation unit 64, and voice data is generated (step S16). In addition, this voice data is stored in the storage unit 115. Based on this voice data, the voice control unit 65 outputs a voice reading out the text data from the speaker 112 (step S17).

Next, a case in which the above-described playback switch 118 is set to the second setting will be described with reference to the flowchart in FIG. 11. Steps S21 to S26 shown in FIG. 11 are the same as steps S11 to S16 in FIG. 9, and therefore the descriptions thereof will be omitted. After voice data is generated in step S26, when the playback switch 118 is pressed (YES in step S27), a playback command is transmitted to the voice control unit 65, and the voice control unit 65 outputs a voice reading out the text data, from the speaker 112 (step S28). Therefore, the reading voice is not output until the play switch 118 is pressed (NO in step S27). Also, when the playback switch 118 is pressed, the voice control unit 65 stores information indicating that the reading voice has been played back, in the storage unit 115 (step S29). As a result, it is possible to confirm afterwards that the reading voice has been played back. Note that the order of steps S28 and S29 may be reversed.

Thus, each time a status is written to the internal memory 311 of the production facility 3, a notification regarding the status is provided by the LED unit 12 using light, and is also provided as a voice output from the speaker 112.

### <4. Features>

As described above, the present embodiment can achieve the following effects.

(1) A notification regarding the status of the production facility 3 can be provided using both light and sound, and therefore the user can check the status of the production facility 3 both visually and audibly.

(2) The production facility 3 only requires that text data for voice data be prepared in advance. Therefore, compared to generating voice data, it is easier to generate data, and it is possible to significantly reduce the time for generation. Therefore, it is possible to shorten the time until the installation of the status notification device 1. Also, text data is generated and stored instead of voice data, and therefore the amount of data can be reduced, and text data corresponding to various kinds of voices can be easily generated. Furthermore, in the network 7, it is only necessary to transmit text data with a small size, and therefore it is possible to shorten the data transmission time, and shorten the time until the status notification is provided.

(3) By setting the playback switch 118 to the second setting, it is possible to stop the output of voice messages that are inconvenient if heard by unrelated users. In addition, when the status of the production facility 3 changes, if the user is not around the status notification device 1, the user can hear the content of the status by pressing the playback switch 118 afterwards. Furthermore, the fact that the voice has been played back is stored when the playback switch 118 is pressed. Therefore, it is possible confirm that the notification has been recognized.

### <5. Modifications>

Although the first embodiment of the present invention has been described above, the present invention is not limited to the above-described first embodiment, and various modifications may be made without departing from the spirit thereof. Note that the modified examples described below can be combined as appropriate. In addition, the following modifications may be made to the second embodiment described below, as appropriate.

<5-1>

In the above-described above, the text or command in the light information part 21 of the transmission data 2 is used to cause the LED unit 12 to emit light. For example, it is possible to change the method for emitting light may be changed according to the content of the text data in the voice message part 22. For example, if the content of the text data in the voice message part 22 requires an urgent response, such as “the temperature is abnormal”, the light emission control unit 63 may increase the intensity of the light emission or change (for example, shorten) the flashing period of thereof, to enhance the degree of visibility.

<5-2>

In the above-described embodiment, a reading voice is output from the speaker 112 based on the voice message part 22 of the transmission data 2. It is possible to generate voice data so that the reading voice changes depending on the content of the text data in the voice message part 22. For example, if the content of the text data in the voice message part 22 requires an urgent response, such as “the temperature is abnormal”, the voice control unit 65 may change at least one of the loudness, pitch, timbre, and playback speed of the voice to be played back, to enhance the degree of audibility. For example, it is possible to draw attention to the voice by increasing the volume of the voice to be played back or raising the pitch.

Note that such changes in the voice may also be made by the voice data generation unit 64. That is to say, it is possible to generate voice data in which at least one of the volume, pitch, timbre, and playback speed of the voice to be played is changed according to the content of the text data in the voice message section 22.

<5-3>

In the above-described embodiment, voice data is generated based on the text data included in the transmission data 2. Various kinds of information may be added to the text data that is the basis of the voice data. For example, it is possible to add information that specifies the production facility 3 whose status has changed (the number, IP address, etc. of the production facility 3), and the time at which the status change occurred, to the text data. As a result, the voice data generation unit 64 can generate voice data to which a voice reading out the production facility 3 whose status has changed and the time are added as well as the status.

<5-4>

If the playback switch 118 is not pressed for a predetermined time, the state notification device 1 may notify a predetermined user of the status change by e-mail, telephone, or the like. As a result, it is ensured that the user recognizes the change in the state of the production facility 3.

<5-5>

The light emission unit according to the present invention may be other than the LED unit 12, and may be a light source such as a light bulb if it can emit a plurality of types of light. For example, it is possible to employ monochromatic light if a plurality of patterns of flashing light can be emitted. In addition, the type of the speaker 112 used as the voice unit according to the present invention is not particularly limited, and need only be able to output reading voices.

<5-6>

In the above-described embodiment, the voice data generation unit 64 is realized by the control unit 114. However, for example, a software module that generates voice data using a known TTS technique may be provided separately.

<5-7>

The storage unit 115 stores voice data, and, for example, when the reception unit (acceptance unit) 61 receives text data that is the same as voice text data received in the past, the voice data corresponding to the text data, stored in the storage unit 115, may be read out and the reading voice may be played back using the voice data. As a result, it is possible to shorten the time required to generate voice data.

<5-8>

The status notification device 1 may be an information processing device designed specifically for the service provided, a general-purpose desktop PC, a tablet PC, etc. Therefore, the form of status notification device shown in FIGS. 6 and 7 is an example, and may be modified as appropriate. In addition, although a status notification device 1 that is provided with the LED unit 12 and the speaker 112 is used in the above-described embodiment, a computer such as a PLC (the status notification unit according to the present invention) that includes the above-described control unit 114 may be prepared, and the computer to which an LED unit, a speaker, and a storage device are externally connected may be used as the status notification device. In addition, a computer that includes the above-described control unit 114 may be built into the device to be monitored, as the status notification unit.

<5-9>

Although the case of providing a notification regarding the status of a production facility 3 is taken as an example in the above-described embodiment, the device to be monitored by the status notification device 1 according to the present invention may be other than the production facility 3, and may be a printer, a server, a network camera, a disaster prevention system, a crime prevention system, an entrance/exit system, an environment monitoring system, an order receiving/ordering system, or any other device whose status changes. Also, the device to be monitored according to the present invention is not limited to having the configuration of the production facility 3 described above, and may be any device that can at least store status changes and generate transmission data based thereon.

### B. Second Embodiment

Hereinafter, a second embodiment of a status notification device according to the present invention will be described with reference to the drawings. The second embodiment is different from the first embodiment in that (1) the production facilities do not generate transmission data and in (2) the software configuration of the status notification device. Therefore, in the following, the differences from the first embodiment will be mainly described, and descriptions of the same components will be omitted.

### <1. Production Facilities>

As described above, the production facilities do not generate transmission data, but it is the same that status changes are written to the internal memory of the PLC.

### <2. Status Notification Device>

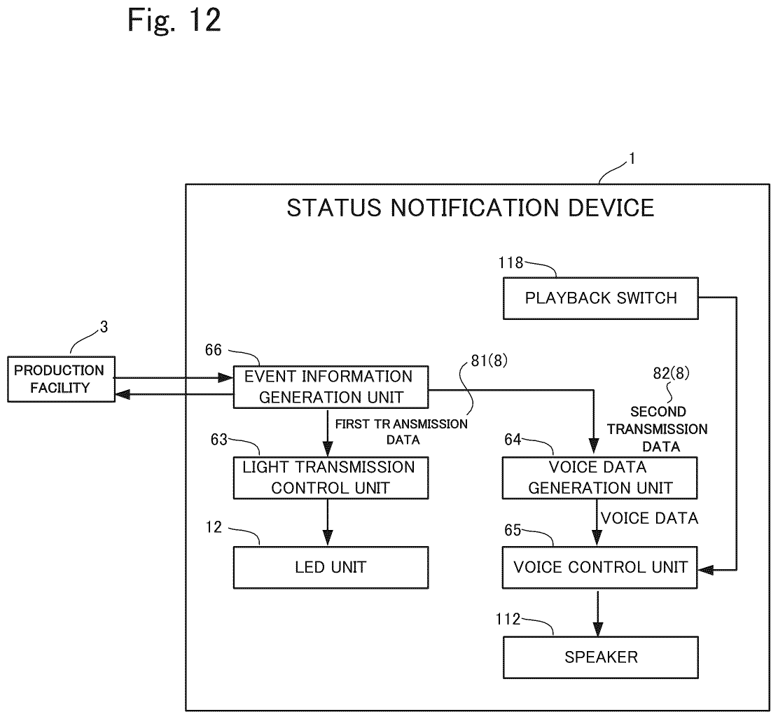

Since the production facilities 3 according to the present embodiment do not transmit transmission data, the software configuration of the status notification device 1 is different. The following provides descriptions with reference to the block diagram shown in FIG. 12.

As shown in FIG. 12, the control unit 114 of the status notification device 1 loads the status notification program 151 stored in the storage unit 115 to the RAM, and thereafter interprets and executes the status notification program 151, using the CPU thereof, to function as a computer that includes the light emission control unit 63, the voice data generation unit 64, the voice control unit 65, and an event information generation unit 66. The components other than the event information generation unit 66 are the same as those in the first embodiment, and therefore the descriptions thereof will be omitted.

The event information generation unit 66 reads the internal memory 311 of the PLC 31 of the production facility 3 at predetermined time intervals to monitor status changes. When the event information generation unit 66 detects that the internal memory 311 has been rewritten, transmission data 8 is generated based on the content of the internal memory 311. The transmission data 8 includes first transmission data (first event information) 81 and second transmission data (second event information) 82. The pieces of transmission data 81 and 82 are generated with reference to notification data 9 that is stored in the storage unit 115.

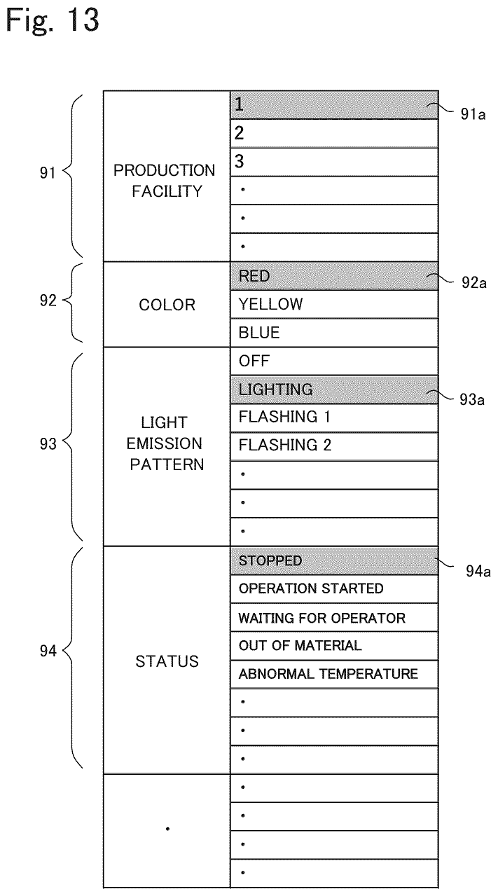

The notification data 9 is constituted by pieces of data that have been registered in advance so as to correspond to the detected statuses (see FIG. 3). For example, as shown in FIG. 13, pieces of text data respectively indicating the number (or the IP address) 91 of the production facility, a light emission color 92, a light emission pattern 93, and a status 94 have been registered. In addition, the notification data 9 has been registered so that the detected status and one of the pieces of text data correspond to each other.

For example, if the status written to the internal memory 311 shown in FIG. 3 is “stopped”, pieces of transmission data 81 and 82 corresponding to this “stopped” are generated. For example, if pieces of text data “red” (light emission color) 92a, “lighting” (light emission pattern) 93a, and “stopped” (text indicating the status) 94a have been registered as the pieces of notification data 9 corresponding to “stopped” (the gray portions in FIG. 13), the event information generation unit 66 generates text data that includes “red, flashing” or a command indicating these pieces of data as the first transmission data 81 to be transmitted to the light emission control unit 63, and generates text data that includes “stopped” as the second transmission data 82 to be transmitted to the voice data generation unit 64. This text data may also include the number or IP address of the production facility 3 whose status has changed, and the time at which the status changed. The subsequent processing is the same as that in the first embodiment.

### <3. Features>

As described above, the present embodiment can achieve the following effects.

(1) The event information generation unit 66 in the status notification device 1 can generate the pieces of transmission data 81 and 82. Therefore, even if the production facilities 3 do not have the function of generating transmission data, the status notification device 1 can provide a notification regarding the status of each production facility 3.

(2) The status notification device 1 stores that notification data 9 that is the basis of the pieces of transmission data 81 and 82. Therefore, the memory capacity of each production facility 3 can be reduced, which contributes to cost reduction. Also, the content written to the internal memory 311 does not have to include colors. It suffices if at least statuses are stored therein.

(3) The notification data 9 shown in FIG. 13 is an example, and may be set as appropriate according to the statuses to be written to the internal memory 311. For example, items other than those shown in FIG. 13 may be added as appropriate. Therefore, a notification can be provided regarding various statuses. Therefore, it is possible to generate transmission data that includes statuses other than those described above, and to output a voice indicating a more detailed status.

Note that the status notification device according to the first embodiment may be provided with the event information generation unit 66 according to the second embodiment so as to support both the production facilities that can generate transmission data and the production facilities that cannot generate transmission data.

### LIST OF REFERENCE NUMERALS

1 Status Notification Device
118 Playback Switch
3 Production Facility (Monitored Device)
61 Reception Unit (Acceptance Unit)
62 Data Determination Unit (Acceptance Unit)
63 Light emission Control Unit
64 Voice Data Generation Unit
65 Voice Control Unit
21 Light Information Part (First Event Information)
22 Voice Message Part (Second Event Information)

1. A status notification unit configured to provide a notification regarding a status of a monitored device, using a light emission unit and a voice unit, the monitored device generating first event information that includes light emission data regarding light emission, and second event information that includes text data corresponding to a voice to be played back, the status notification unit comprising:
an acceptance unit configured to accept the first event information and the second event information from the monitored device;
a light emission control unit configured to control light emission performed by the light emission unit, based on the first event information accepted by the acceptance unit;
a voice data generation unit configured to generate voice data to be played back by the voice unit, based on the second event information accepted by the acceptance unit; and
a voice control unit configured to control the voice to be played back by the voice unit, based on the voice data.

2. The status notification unit according to claim 1,
wherein the light emission control unit is configured to change a method by which the light emission unit emits light, based on the second event information.

3. The status notification unit according to claim 1,
wherein the voice data generation unit is configured to generate the voice data so as to change at least one of a volume, pitch, timbre, and playback speed of the voice to be played back according to the content of the text data included in the second event information.

4. The status notification unit according to claim 1,
wherein the voice control unit is configured to control the voice unit so as to change at least one of a volume, pitch, timbre, and playback speed of the voice to be played back according to the content of the text data included in the second event information.

5. The status notification unit according to claim 1, further comprising:
a storage unit configured to store the generated voice data,
wherein when text data that is the same as the text data included in the second event information accepted in the past is received, the voice to be played back by the voice unit is controlled based on the voice data stored in the storage unit.

6. The status notification unit according to claim 1,
wherein the voice data generation unit is configured to generate the voice data so that the voice data includes at least one of: times at which the first and second event information were accepted; and information for specifying the monitored device.

7. The status notification unit according to claim 1, further comprising:
a playback command acceptance unit configured to accept a command for playing back the voice,
wherein the voice control unit is configured to perform control so that the voice unit plays back the voice when the playback command is accepted by the playback command acceptance unit.

8. A status notification device comprising:
a light emission unit configured to emit light;
a voice unit configured to emit a voice; and
a status notification unit according to claim 1.

9. A status notification device comprising:
a light emission unit configured to emit light;
a voice unit configured to emit a voice;
a playback switch; and
the status notification unit according to claim 7,
wherein the playback command acceptance unit is configured to accept the playback command via the playback switch.

10. A status notification method for providing a notification regarding a status of a monitored device, using a light emission unit and a voice unit, the monitored device generating first event information that includes light emission data regarding light emission, and second event information that includes text data corresponding to a voice to be played back, the status notification method comprising:
accepting the first event information and the second event information from the monitored device;
generating voice data to be played back by the voice unit, based on the accepted second event information;
controlling the voice to be played back by the voice unit, based on the voice data; and
controlling light emission performed by the light emission unit, based on the accepted first event information.

11. A non-transitory storage medium storing therein a status notification program for providing a notification regarding a status of a monitored device, using a light emission unit and a voice unit, the monitored device generating first event information that includes light emission data regarding light emission, and second event information that includes text data corresponding to a voice to be played back, the status notification program enabling a computer to execute:
accepting the first event information and the second event information from the monitored device;
generating voice data to be played back by the voice unit, based on the accepted second event information;
controlling the voice to be played back by the voice unit, based on the voice data; and
controlling light emission performed by the light emission unit, based on the accepted first event information.
